(19) United States
(12) Patent Application Publication
(10) Pub. No.: US 2020/0352183 A1
(43) Pub. Date: Nov. 12, 2020

(54) PROCESS AND ASSEMBLY FOR THE TREATMENT OF THE ATMOSPHERE OF A STORAGE OF PLANT PRODUCTS WITH HIGH RELATIVE HUMIDITY

(71) Applicant: XEDA INTERNATIONAL S.A., SAINT ANDIOL (FR)

(72) Inventor: Alberto SARDO, CHATEAURENARD (FR)

(21) Appl. No.: 16/764,096

(22) PCT Filed: Nov. 15, 2018
(86) PCT No.: PCT/EP2018/081371

§ 371 Date: May 14, 2020

(30) Foreign Application Priority Data
Nov. 15, 2017 (FR) 17 60756

(51) Int. Cl. A23B 7/148; A23L 3/3418; A23B 9/20

(52) U.S. Cl. CPC A23B 7/148; A23B 9/20; A23L 3/3418

(57) ABSTRACT

The method for treating the atmosphere of a storage in a closed chamber of plant products leads to relative humidity levels greater than 99%, wherein the process comprises at least one step of contacting the atmosphere with a flow of liquid by circulation in a packing. The atmosphere is moistened with water vapor at room temperature until saturation of air.

The invention generally relates to the preservation of plant products stored in large volume chambers.

It is necessary to control a large number of parameters to control the process of maturation of stored plant products.

The respiration of the preserved plant products depends on the plant variety, their state of maturation, the storage temperature and the composition of the atmosphere.

During their respiration, plant products absorb oxygen and produce carbon dioxide and water. Typically, the metabolism is slowed down or inhibited by the reduction of the oxygen level in the atmosphere. However, very low oxygen levels, usually coupled with low temperatures, are needed to achieve a significant reduction in metabolism, without causing fermentation.

It is generally necessary to maintain a certain humidity level in the storage atmosphere, so that the plant products do not dry out and get a wrinkled appearance. Thus, generally, the plant products are stored in an atmosphere having a relative humidity (RH) of between 90 and 95%, at most. This limitation is due to the strong impact of condensation that necessarily takes place in conventional installations, due in particular to:
the cooling of plant products, which have upon their entry a temperature above the storage temperature;
the warmer walls of the storage space that are in contact with the outside air;
the respiration of stored plant products, very exothermic, which requires cooling of the storage space and also creates condensation on the exchanger. In practice, the best cold rooms using large exchange surfaces and brine as an intermediate liquid in order to reduce the air/cold surface temperature difference, can hardly maintain an RH of the order of 95%.

In addition, the more the RH increases, the more the condensation effect increases and the more difficult it becomes to evaporate at constant temperature because air with extremely high humidity will have difficulty in later evaporating water.

Van den Berg, L. and C. P. Lentz, 1978, High-humidity storage of vegetables and fruits. HortScience 13:565-569, experimented with the storage of vegetables with relative humidity up to 99%, with a refrigerated air system outside the storage space. However, the installations they describe do not achieve a relative humidity greater than 99% due to the condensation that inevitably occurs on the walls due to the temperature difference between the outside and indoor air.

FR 201658046 filed on 30 Aug. 2016 describes facilities for humidifying the storage atmosphere but without considering relative humidity levels at 99%.

It has now been discovered that the physiology of stored plant products may be inhibited by storing them in an atmosphere with very high relative humidity, greater than 99%.

To this end, the invention relates to a method for preserving plant products, comprising the storage of the products in an atmosphere whose relative humidity (RH) is equal to or greater than 99%, typically strictly greater than 99%, characterized in that the atmosphere is humidified with water vapor at room temperature until saturation of the air.

“Relative humidity” (RH) is the moisture content of the air which corresponds to the ratio of the partial pressure of the water vapor contained in the air to the saturation vapor pressure (or vapor pressure) at the same temperature. It is therefore a measure of the ratio between the water vapor content of the air and its maximum capacity to contain it under these conditions.

According to one embodiment, the method comprises at least one step of contacting the atmosphere with an aqueous flow by circulation in a packing.

This contacting is generally performed within the storage space of the plant products.

According to one embodiment, the method comprises a step of measuring the humidity in the storage atmosphere, wherein the flow rate of the atmosphere at the contacting step is adjusted according to the temperature and/or measured humidity. Typically, the relative humidity can be measured by a hygrometer.

At high RH levels, especially above 99%, hygrometer measurement is not sufficiently accurate to determine RH variations that may substantially impact the physiological development of plant products.

The inventors have therefore indirectly determined the RH, while allowing the necessary precision, by using the principle of the reaction: sugar+O₂→CO₂+H₂O.

I.e. if v is the rate of progress of the reaction and RH is the relative humidity, v=(100−RH)/100.

To maintain equilibrium, the higher the H₂O concentration increases, the less the reaction proceeds.

By measuring the variation of the CO₂ produced, it is therefore possible to assess and quantify the variation of the RH ratio in an extremely accurate manner and to check the impact of even small variations on the physiological development.

CO₂ production under different conditions may be determined very precisely:
by direct reading of the concentration in the atmosphere,
or by using an absorbent product (such as sodium hydroxide, potassium hydroxide or calcium hydroxide) in the recirculated water and determining the amount of CO₂ absorbed in a certain time under the experimental conditions.

It is also possible to determine the degree of progress of the reaction and thus the physiological development by measuring:
1) the amount of heat produced;
2) the amount of dry matter lost.

The term “aqueous phase” or “aqueous stream” means a volume of water possibly in dynamic circulation comprising mainly water, in which, optionally, one or more agents such as active agents, additives, etc., are added.

The aqueous phase or aqueous stream typically has a temperature between 0 and 20° C.

The RH rate may be adjusted thanks to three parameters: the air flow, the water flow and the contact surface between the air and the water, which must be dimensioned according to the quantity of plant products stored in the storage space.

Generally, the hourly flow of air is greater than or equal to 25% of the storage volume, to ensure uniform humidification.

Typically, the air flow rate (in kg/h) to be humidified is between 20 and 10,000% of the weight of the stored plant products.

Typically, the water flow is greater than or equal to 10% of the air flow (kg/h).

The method may further have one or more of the following features considered individually or in any technically feasible combination:
the storage temperature of plant products is between −1 and 20° C., especially between 10 and 20° C.; advantageously, it is no longer necessary to cool the storage atmosphere to the very low temperatures that are usually required. By slowing down the metabolism of plant products, the method according to the invention allows access to higher storage temperatures. An improvement of the organoleptic properties therefore follows, as well as an energy gain;
the air flow is greater than 0.1 volume of the hourly storage chamber; in particular between 2000 and 10000 m³/h;
the aqueous stream is greater than 10% of the air flow by weight (kg); in particular between 500 and 200 kg/h;
the aqueous phase comprises at least one biocidal and/or safener product, with a boiling point of between 60 and 280° C., wherein the aqueous phase is evaporated at the contacting step at a temperature below 50° C.;
the contacting step aims to eliminate the dust and the aroma from the atmosphere;
the aqueous phase contains at least one additive, wherein the contacting step aims to remove CO₂ and/or ethylene from the atmosphere;
the at least one additive comprises an oxidant, for example permanganate or dichromate;
the method comprises a step of measuring the concentration of the biocidal product and/or safener product in the atmosphere, wherein the flow rate of the flow of the other liquid to the contacting step is adjusted according to the measured concentration;
the method comprises:
   a step of collecting the aqueous stream resulting from the contacting step;
   a step of regeneration of the aqueous stream resulting from the contacting step, during which the aqueous stream is brought into contact with a flow of air outside the storage through circulation in an external packing, wherein the aqueous stream is then reused in the contacting step;
the method comprises a step of measuring the concentration of CO₂ and/or O₂ in the storage atmosphere, wherein the flow rate of the aqueous stream is adjusted as a function of the measured concentration; and
the method comprises a step of measuring the temperature in the storage atmosphere, wherein the flow rate of the atmosphere at the contacting step is adjusted as a function of the measured temperature; and
the method comprises a step of measuring the temperature in the storage atmosphere, wherein the flow rate of the air flow outside the regeneration step is adjusted at least according to the measured temperature.

According to a second aspect, the invention relates to a set to treat the atmosphere of a storage of plant products, wherein the set comprises at least:
a device for bringing the atmosphere into contact with an aqueous stream, comprising a packing;
a device for injecting an aqueous stream into the contacting device;
a device for circulating the storage atmosphere in the contacting device;

wherein the contacting device is so shaped that the atmosphere is brought into contact with the aqueous stream by circulation in the packing, and in that the atmosphere has a relative humidity greater than 99%.

According to a third aspect, the invention relates to a system comprising a storage of plant products, and a set to treat the atmosphere of the storage having the above characteristics. The storage advantageously contains a quantity of plant products.

The method may be advantageously carried out with the treatment unit described in Application FR1658046.

According to one embodiment, the RH of the storage atmosphere is greater than 99.5%.

The method according to the invention reduces the physiological development of plant products by slowing it down over time, thereby inhibiting the phenomena associated with aging such as scalding of pomaceous (apples, pears, etc.), germination of tubers, loss of weight of any plant product. With a very high RH, the plants are better preserved and a greater proportion of them are therefore suitable for marketing at the time of opening of the storage. Losses due to deterioration are reduced. The development of physiological diseases caused by the evolution of stored plants is slowed down or prevented. The absence of senescent products promotes conservation.

Without being bound by the theory, it has been discovered that the inhibition of the metabolism of stored plant products increases non-linearly with the relative humidity of the storage atmosphere. Thus, according to one embodiment, the method according to the invention inhibits the physiological development of plant products, so that when it is related to a reference value 1 at 95% relative humidity of the storage atmosphere, the blockage of development varies as follows:

5 at 99% RH, 10 at 99.5% RH, 50 at 99.9% RH, 100 at 99.95% RH, 500 at 99.99% RH.

The set of the invention may furthermore have one or more of the following characteristics, considered individually or in any technically feasible combination:
the contacting device comprises a reserve and a dose of aqueous phase stored in the reserve;
the aqueous phase may comprise at least one biocidal and/or safener product, with a boiling temperature of between 60 and 280° C., wherein the aqueous phase is evaporated in the contacting device at a temperature below 50° C.;
the contacting device is designed to remove dust and aroma from the atmosphere;
the aqueous phase contains at least one additive, wherein the contacting device is designed to remove CO₂ and/or ethylene from the atmosphere;
the set comprises a device for regenerating the aqueous flow, with:
   an external device for contacting and comprising an outer packing;
   a device for injecting the aqueous stream coming from the contacting device into the external contacting device;
   a device for circulating a flow outside the storage (3) in the external contacting device; and

wherein the external contacting device is so shaped that the aqueous stream is brought into contact with a flow of air outside the storage through circulation in the outer packing, and is then recycled into the contacting device.

Other features and advantages of the invention will become apparent from the detailed description given below, for information only and in no way limitative, with reference to the appended figures, wherein:

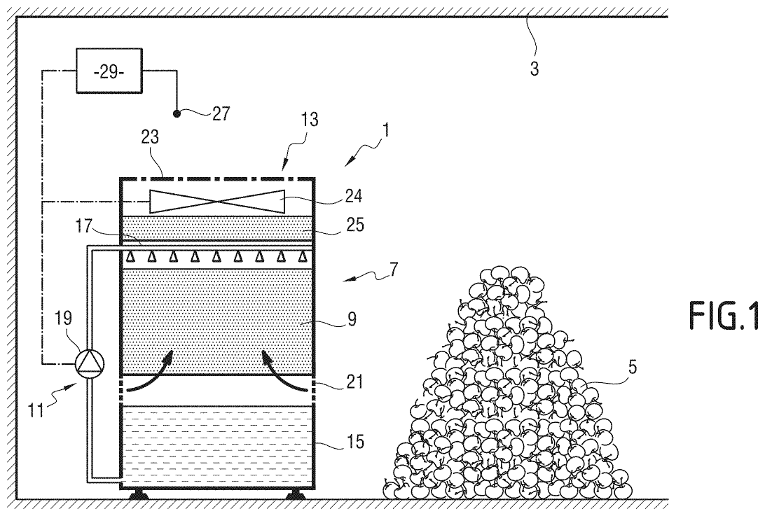

FIG. 1 shows a simplified schematic representation of a first embodiment of the invention;

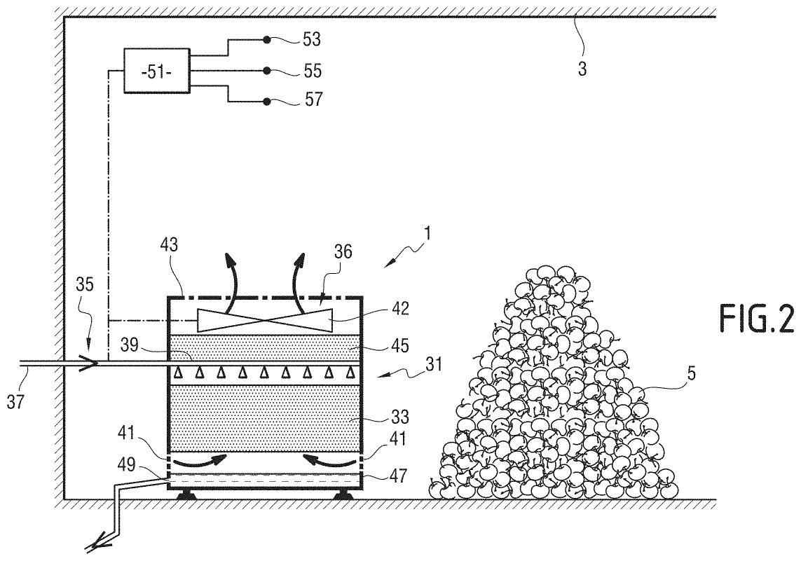

FIG. 2 shows a simplified schematic representation of a second embodiment of the invention;

The storage is a closed enclosure, in the sense that the exchanges between the storage atmosphere and the outside, in particular gas exchange, are very reduced in order to avoid jeopardizing the conservation of the plant products.

The plant products are typically vegetables, fruits, tubers, grains, flowers or seedlings, which are stored after harvest and before shipment to retailers.

The set 1 illustrated in the figures, and the corresponding method, is intended for the treatment of the atmosphere of a storage 3 for plant products 5 advantageously having a volume greater than 200 m³. According to one embodiment, the storage volume is typically greater than 200 m³, preferably greater than 500 m³ and more preferably greater than 1000 m³. Thus, the assembly and the method may typically be intended to be applied to large volume storage, for example a chamber, a silo, a greenhouse or any other premises for the storage of plant products.

According to another embodiment, the set and the storage method may also be intended to be applied to smaller volumes such as storage areas of retail stores (supermarkets, etc.) or transport (trucks, etc.).

The set 1 comprises at least:
a contacting device comprising a packing;
an injection member for an aqueous stream in the contacting device;
a member for circulating the storage atmosphere in the contacting device.

The contacting device is so shaped that the atmosphere is brought into contact with the aqueous stream by circulation in the packing.

The corresponding method comprises at least one step of contacting the atmosphere with an aqueous stream by circulation in a packing.

The contacting is performed in any type of device containing the packing. For example, it may be performed in a packing tower.

The term “packing” here refers to any type of structure that makes it possible to obtain a large contact surface between a liquid phase and a gaseous phase, and thus to improve the exchanges between the liquid phase and the gaseous phase.

The packing may thus be a loose type packing or a structured type packing.

In the present case, the packing is for example of the Raschig or Pall ring type, or is a honeycomb structured packing.

It is typically made of a plastic material.

The contacting makes it possible to carry out particularly effective transfers between the flow of liquid and the atmosphere of the storage. The large exchange surface makes it possible to generate large quantities of water vapor at room temperature, thus avoiding condensation.

In particular, when the storage is equipped with an air conditioning device that is intended to maintain the temperature within a predetermined range inside the storage, condensation of the water vapor contained in the atmosphere occurs, in particular, at the heat exchangers or condensers of the air conditioning device.

The aqueous phase flowing in the contacting device is partially evaporated, which at least partially offsets the condensed water vapor in the air conditioning device.

As will be described below, these transfers are essentially to humidify the atmosphere at a relative humidity greater than 99%, especially greater than 99.5%. They may also serve, moreover, different purposes, depending on the nature of the aqueous phase:
filtration of the atmosphere, in particular the trapping of dust and suspended soil in the atmosphere;
elimination of CO₂ released by plant products;
elimination of ethylene (C₂H₄) released by plant products;
elimination of aromas released by plant products;
reintegration of oxygen consumed by plant products;
sterilization of the atmosphere;
application of a protective treatment for plant products.

The storage atmosphere here corresponds to the volume of gas filling the storage and bathing the plant products.

This atmosphere typically includes air and water vapor, plus gases and products released by plant products as they mature.

Alternatively, the atmosphere may be a modified atmosphere, for example depleted of oxygen. This is particularly the case for the storage of certain plant products such as apples.

According to a first embodiment illustrated in FIG. 1, the aqueous phase used may comprise at least one biocidal and/or safener product, with a boiling point between 60 and 280° C., wherein the liquid is evaporated at the contacting step at a temperature below 50° C.

When the product is a biocidal product, the treatment aims to sanitize the storage. Typically, this treatment is applied when the storage does not contain plant products.

When the product is a safener product, which may also be called a phytosanitary product, the treatment aims to protect plant products, prevent the development of diseases and/or rotting, such as fungicidal or anti-germinating products.

The liquid contains only biocidal products or phytosanitary products, or comprises one or more biocidal products mixed with one or more plant protection products.

At least one of the phytosanitary products is chosen from the following list: essential oil, terpenes, saturated or unsaturated C3 to C9 alcohol, for example isopropanol, iso-octanol, 2-ethylhexanol, volatile synthetic products such as glutaraldehyde, hexanal, dimethylnaphthalene and 3-decene-2-one.

The essential oil is, for example, selected from the group consisting of mint oil, clove oil, rose oil, thyme oil, oregano oil. Alternatively, the liquid may comprise one of the constituents of these oils, selected from the group consisting of L-carvone, eugenol, geraniol, thymol, carvacrol.

For a disinfection application, the biocidal product may be a volatile product, natural or synthetic, having biocidal properties, such as clove oil, thyme oil, geraniol, ethyl alcohol, glutaraldehyde.

Typically, the aqueous phase comprises only the product(s), without solvent or adjuvant. Alternatively, it may comprise an aqueous or organic solvent in which is dissolved the product(s) and one or more adjuvants. The aqueous solvent is, for example, water. The organic solvent is, for example, a solvent of the type described in FR 2 791 910 or glycols, di-glycols and their relative esters. The adjuvants are, for example, substances capable of transporting the active substance(s) or capable of giving a dilution effect.

In any event, the aqueous phase during the contacting step is vaporized at a temperature below 50° C., preferably below 20° C., especially between −2° C. and +12° C. and, in particular, between 0 and 10° C. For example, the aqueous phase may be evaporated at room temperature.

As illustrated in FIG. 1, the treatment set 1 comprises:
the contacting device 7 comprising a packing 9;
the device 11 for injecting the aqueous stream into the contacting device 7;
the device 13 for circulating the storage atmosphere in the contacting device 7.

The contacting device 7 is so shaped that the atmosphere is brought into contact with the aqueous flow by circulation in the packing 9. Typically, the contacting device 7 is a packing tower, which is has a vertical axis in the example shown.

The injection device 11 comprises a reserve 15 of aqueous phase, and a dose of aqueous phase stored in the reserve 15. The reserve 15 is typically a tank, placed vertically under the packing 9.

The injection device 11 is arranged to inject the aqueous phase above the packing 9.

For this purpose, it typically comprises one or more sprinklers 17, for example ramps, placed above the packing, and a transfer member 19, such as a pump, sucking the liquid into the reservoir 15 and discharging it in the sprinkler(s) 17.

The circulation device 13 is arranged to create an upward circulation of the atmosphere inside the contacting device 7.

To do this, the contacting device 7 comprises one or more inlets 21 for the atmosphere opening inside the contacting device 7, under the packing 9.

Each inlet 21 communicates fluidly with the interior of the storage 3.

The contacting device has an outlet 23 for the atmosphere loaded in evaporated aqueous phase, and placed in the upper part of the contacting device above the packing 9. The outlet 23 is fluidly connected with the interior of the storage 3.

The circulation device 13 comprises, for example, a circulation member 24 such as a fan or a blower, placed above or below the packing 9, typically at the top of the contacting device 7.

The circulation member 24 draws the loaded atmosphere into the evaporated aqueous phase above the packing 9, and delivers it into, or to, the outlet 23.

The packing 9, as specified above, is of any suitable type.

Preferably, the contacting device 1 comprises a drop separator 25, placed above the sprinklers 17, and more precisely between the sprinklers 17 and the circulation member 24.

In an exemplary embodiment, the contacting device 7 has a square, substantially constant, horizontal section of 700×700 mm. The reserve 15 has the same horizontal section, and has a height of between 500 and 700 mm. The device has four inlets 21, each arranged on one side. The packing 9 has a height of about 1 m. The packing is placed for example 700 mm below the inlet of the aqueous phase, while the drop separator 25 is placed 300 mm above the inlet of the aqueous phase.

The treatment set 1 preferably comprises a sensor 27 for measuring the concentration of the biocidal product and/or safener product in the atmosphere and an electronic device 29 informed by the sensor 27.

The electronic device 29 is programmed to control the injection device 11 and/or the circulation member 13.

More specifically, it is, in particular, programmed to adjust the flow rate of the aqueous stream as a function of the concentration measured by the sensor 27. Preferably, it also drives the circulation member 24.

The electronic device 29 is, for example, a computer or a part of a computer. Alternatively, the electronic control device 29 is implemented in the form of field programmable gate array components (FPGA) or in the form of an application specific integrated circuit components (ASIC,). The electronic device 29 is programmed to implement a treatment strategy.

The treatment strategy may be of any type. The treatment may be spread over a long time, in order to gradually inject the aqueous phase in a small amount, and so maintain the desired relative humidity constantly at the desired level inside the storage.

Conversely, it is possible to carry out a treatment aimed at rapidly obtaining the saturation concentration of water in the atmosphere, over a short period. This allows, for example, the moistening of empty or partially empty storage chambers.

This effect may be obtained because the contact surface between the aqueous phase and the atmosphere is high, as a result of the presence of the packing. The machine sold under the name XEDAVAP®, whose principle is to inject the aqueous phase for evaporation on a fabric swept by a current of air, has a maximum developed fabric surface of about 4 m². This allows evaporation, for example, of 5 liters of water/day.

On the contrary, the treatment set of the present invention provides a contact area between the gas and the aqueous phase which may be, for example, up to 70 m². It is thus possible to evaporate much larger amounts of water, for example about 70 liters of water per day for a volume of water of 1000 liters and 1000 tons of stored products. It is thus possible to reach the saturation concentration of the water in the atmosphere more quickly.

The operation of the set is as follows.

The aqueous phase to be evaporated is placed in the reserve 15. The transfer member 19 forces the aqueous phase into the sprinkler members 17, which project the aqueous phase towards the packing 9. The member 24 for circulation of the atmosphere creates an ascending gas flow. The atmosphere enters the device 7 through the inlets 21, and flows upwards through the packing 9. The aqueous phase flows downwards through the packing 9, wherein part of the aqueous phase is evaporated upon contact with the gas flow and is entrained with the atmosphere in the form of vapor. The fraction of the aqueous phase which is not evaporated falls back into the reserve 15. Then it is recycled. The atmosphere loaded with evaporated water passes through the drop separator 25 and is discharged by the circulation member 24 to the outlet 23.

The set 1 is typically placed inside the storage. It thus directly sucks the storage atmosphere through the inlet(s) 21 and outputs this atmosphere loaded with water vapor directly into the storage via the outlet 23.

The aqueous phase flow rate is for example 3 m³/hour, and the flow rate of the atmosphere of about 2000 m³/hour.

The treatment method according to the first embodiment comprises a step of contacting the atmosphere of the storage 3 with at least one aqueous stream by circulation through another packing, wherein the aqueous phase comprises at least one biocidal product and/or safener volatile with a boiling temperature between 60 and 280° C., wherein the aqueous phase is evaporated in the contacting step at a temperature below 50° C.

Typically, the method comprises a step of measuring the concentration of the biocidal product and/or safener volatile in the atmosphere, wherein the flow rate of the aqueous stream at the contacting step is adjusted as a function of the measured concentration.

Preferably, the injected aqueous phase is collected under the packing, in a reserve, and recycled to the contacting step.

The method is intended to be implemented by the treatment set 1 described above. Conversely, the treatment set 1 described above is particularly suitable for implementing the method.

A second embodiment of the invention will now be described with reference to FIG. 2. Only the points where this second embodiment differs from the first will be detailed below.

In addition to humidifying the atmosphere in the second embodiment, the contacting aims to remove dust and aroma from the atmosphere. The aromas are released by the plant products during their maturation.

The set 1 comprises, as in the first embodiment:
a contacting device 31 comprising a packing 33;
a device 35 for injecting the aqueous stream into the contacting device 31;
a device 36 for circulating the atmosphere in the contacting device 31.

The injection device 35 comprises a water inlet 37, feeding one or more sprinklers 39 such as ramps. The water inlet 35 is typically connected to a water distribution network, or a water tank. Water is typically pure water, with no additives. The water is at a temperature below 50° C., typically at room temperature.

The circulation device 36 is arranged to create an upward circulation of the atmosphere inside the contacting device 31.

To do this, the contacting device 31 comprises one or more inlets 41 for the atmosphere opening inside the contacting device 31, under the packing 33. The circulation device 36 comprises a circulation member 42, for example a fan or a blower, placed above the packing 33 to discharge the atmosphere via an outlet 43 communicating fluidly with the interior of the storage. A drop separator 45 is interposed vertically between the sprinkler member(s) 39 and the circulation member 42.

The contacting device 35 further comprises a tank 47 placed under the packing 33, and designed to collect the water which is not evaporated upon contact with the atmosphere in the packing 33. The collection tank 47 has an output 49 typically connected to a sewer.

Thus, the wastewater containing the undesirable products, i.e. at least the dusts and aromas, is discharged from the contacting device 7 to the sewers. It is not recycled.

Alternatively, the water may be recycled after being purified.

As in the first embodiment, an electronic device 51 controls the circulation member 42 and the injection device 35.

Typically, the treatment set is operated periodically, for example once a day, so as to sanitize the storage atmosphere.

The flow rate of water is typically between 300 and 500 liters/hour, while the flow rate of the atmosphere through the packing is of the order of 2000 m³/hour.

It should be noted that the device and the method according to the second embodiment, in addition to humidification, trapping of dust and the elimination of aromas, allow, if necessary, enrichment of the oxygen atmosphere.

Plant products stored in storage consume oxygen from the atmosphere through their natural respiration. It is therefore necessary to re-enrich the oxygen atmosphere regularly. In the present case, particularly in the second embodiment, the water supplying the contacting device contains dissolved oxygen, which is partially vaporized when placed in contact with the atmosphere.

Preferably, the assembly 1 comprises a sensor 53 for measuring the temperature inside the storage 3. The electronic device 51 is designed to adjust the flow rate of the liquid flow and/or the flow rate of the atmosphere at least as a function of the measured temperature.

Advantageously, the assembly 1 comprises a sensor 55, that is designed to analyze the concentration of O₂ in the storage atmosphere, typically a gas analyzer. The electronic device 51 is designed to adjust the flow rate of the liquid stream at least as a function of the measured concentration.

For example, the set 1 comprises a hygrometer 57, arranged to measure the humidity of the atmosphere in the chamber 3. The electronic device 51 is programmed to adjust the flow rate of the atmosphere and/or the flow rate of the liquid flow at least according to the humidity measured by the hygrometer 57.

According to a variant of the second embodiment, the aqueous phase placed in contact with the storage atmosphere contains at least one additive, wherein the contacting device is configured to remove CO₂ and/or ethylene from the atmosphere of the storage.

Thus, the aqueous phase comprises water plus an additive dissolved in water. To remove the CO₂, the additive is, for example, sodium hydroxide (NaOH), potassium hydroxide (KOH), quicklime or slaked lime (CaO, Ca(OH)₂).

To remove ethylene, the additive contains a strong oxidant, for example permanganate (MnO₄⁻) or dichromate (Cr₂O₇²⁻) sodium or potassium. Typically, the additive contains sodium permanganate or potassium permanganate or potassium dichromate.

The aqueous phase may contain only an additive for removing CO₂, or only an additive for removing ethylene, or contain an additive for removing CO₂ and an additive for removing ethylene.

The concentration of the various additives is chosen according to the amount of CO₂ and the amount of ethylene to be removed.

For example, the aqueous phase is an aqueous solution of sodium permanganate or potassium permanganate, saturated with permanganate.

As mentioned above, CO₂ and ethylene are released by plant products as they mature.

Thus, in the variant of the second embodiment of the invention, the device and the method make it possible to eliminate the dust, the aromas, the CO₂ and/or the ethylene from the atmosphere, in addition to moistening the atmosphere, and re-enriching the atmosphere with water in O₂.

In this case, the sensor 55 is preferably designed to analyze the concentration(s) of CO₂ and/or ethylene in the storage atmosphere. The electronic device 51 is configured to adjust the flow rate of the aqueous flow as a function of the concentration(s) measured.

The method of treating the storage atmosphere according to the second embodiment thus comprises a step of contacting the atmosphere with an aqueous flow by circulation in a packing.

Typically, the method comprises a step of measuring the concentration(s) of O₂ and/or CO₂ and/or ethylene in the atmosphere, and/or measuring the temperature of the atmosphere, and/or measuring the humidity in the storage atmosphere, wherein the flow rate of the aqueous flow and/or the flow rate of the atmosphere at the contacting step is adjusted as a function of the measurement(s).

The method is intended to be implemented by the treatment set 1 described above. Conversely, the treatment set 1 described above is particularly suitable for implementing the method.

It is important to note also that, in all embodiments, the system is self-regulating. The water for humidifying the atmosphere is vaporized at room temperature, below 50° C., evaporated until saturation of the atmosphere without risk of supersaturation (which is the case when heating). This prevents the water recondensing after injection. This is also true for the evaporation of the biocidal and/or safener product.

Thus, in addition to, or instead of, regulation by measuring the humidity in the atmosphere, it is intended to let the system self-regulate. For example, the system may work continuously. Water at room temperature evaporates to saturation. Once the saturation is reached, there is no more evaporation.

The following examples are given by way of non-limiting illustration of the present invention.

### EXAMPLE 1

1000 tons of potatoes were kept in a room of about 3000 m³, i.e. about 2000 m³ of available space. First, a machine for evaporating dry mint oil (Xeda VAP 1) was used with a dose of 2 g/t/d. Thus, this machine was started with a relative humidity of 85%, a storage temperature of 8° C. and a CO₂ level maintained at 1500-1700 ppm by the opening of the doors of the chamber (approximately 1 hour/day). Then, the machine Xeda VAP 1 was replaced by the machine illustrated in FIG. 1, with a water flow of 1300 kg/h, a water reserve of 1000 l, and an air flow of 4500 m³/h. A similar dose of mint oil mixed with the aqueous phase was evaporated. In order to neutralize the CO₂ so formed, 50 kg of caustic soda is added to the water reserve (1000 l). The CO₂ concentration then fell immediately to 700-870 ppm, with the doors closed continuously. About 1 month later the aqueous solution was still alkaline (pH 9.5): thus the totality of the sodium hydroxide had not been converted into sodium bicarbonate. Nevertheless, the potatoes were perfectly preserved, without rotting or germination.

If all the soda had been converted into bicarbonate, 55 kg of CO₂ should have been absorbed. Since the transformation of sodium hydroxide into bicarbonate was incomplete after 35 days, it may be considered that 55 kg of CO₂ may be absorbed in 40 days, corresponding to the CO₂ production by the 1000 t of potatoes in this period. This gives a value of 55 kg of CO₂ for 40 days, or 1.38 kg/day of CO₂. This value is to be compared with 100 kg/day of CO₂, which should have been produced, according to the data available in the literature.

These results mean that 70 times less CO₂ was produced than theoretically expected. As an illustration, the concentration in the chamber is about 110 ppm (compared to the concentration of 597 ppm outside the chamber).

The respiration reaction is: sugar+O₂→CO₂+H₂O.

This reaction therefore gives the following variation in the inhibition of metabolism, relative to a reference value 1 at 95% relative humidity: 5 at 99% relative humidity, 10 at 99.5% relative humidity, 50 at 99.9% relative humidity, 100 at 99.95% relative humidity, and 500 at 99.99% relative humidity.

A CO₂ production inhibition of about 100 therefore corresponds to 99.95% relative humidity.

1. A method of preserving plant products, comprising:
storing the plant products in a closed chamber with an atmosphere whose relative humidity (RH) is equal to or greater than 99%, wherein the atmosphere is moistened with water vapor at room temperature until saturation of air.

2. The method according to claim 1, further comprising:
bringing the atmosphere into contact with an aqueous stream by circulation in a packing, which comprises one selected from a loose packing and a structured packing.

3. The method according to claim 1, wherein the RH of the atmosphere is greater than 99.5%.

4. The method according to claim 1, wherein the preservation is carried out by slowing down the physiological development of the plant products, thus inhibiting the phenomena associated with aging, which includes scalding, germination, or weight loss.

5. The method according to claim 4, wherein the physiological slowdown, relative to a reference value 1 at 95% relative humidity of the atmosphere, varies as follows:
5 at 99% RH, 10 at 99.5% RH, 50 at 99.9% RH, 100 at 99.95% RH, 500 at 99.99% RH.

6. The method according to claim 5, wherein the storage temperature of the plant products is between −1 and 20° C.

7. The method according to claim 2, such that the temperature of the aqueous stream is between 0 and 20° C.

8. The method according to claim 1, wherein the plant products are selected from the group consisting of fruits, vegetables, bulbs and tubers, flowers, seeds, and seedlings.

9. The method according to claim 1, wherein the method further comprises evaporating a composition comprising both or either a biocidal agent and a safener product.

10. The method according to claim 9 wherein the composition comprises one selected from clove oil and mint oil.

11. The method according to claim 2, wherein the aqueous stream further comprises an agent for neutralization of CO₂, neutralization of aromas or neutralization of ethylene in the atmosphere.

12. The method according to claim 11, wherein the agent neutralizing CO₂ is sodium or potassium hydroxide.

13. The method according to claim 11, wherein the agent for neutralization of aromas or neutralization of ethylene is permanganate or dichromate, sodium or potassium.

14. The method according to claim 2, wherein the method further comprises:
collecting the aqueous stream resulting from the contacting step;
regenerating the aqueous stream resulting from the contacting step, during which the aqueous stream is brought into contact with a flow of air outside the circulation storage in an external packing, wherein the aqueous stream is then reused in the contacting step.

15. The method according to claim 2, wherein the method further comprises measuring the humidity in the atmosphere, wherein the flow rate of the atmosphere at the contacting step is set at least depending on the measured humidity.

16. The method according to claim 2, further comprising:
measuring at least one parameter selected from the group consisting of the concentration of CO₂, the concentration of O₂ in the atmosphere and the temperature of the atmosphere, wherein the flow rate of the aqueous stream at the contacting step or the air flow outside the regeneration step is set based on the at least one measured parameter.
